(19) United States
(12) Patent Application Publication
(10) Pub. No.: US 2020/0388194 A1
(43) Pub. Date: Dec. 10, 2020

(54) SYSTEMS AND METHODS FOR GENERATING AIRCRAFT TRAINING PROGRAMS ADAPTED TO USER CHARACTERISTICS

(71) Applicant: Honeywell International Inc., Morris Plains, NJ (US)

(72) Inventors: Mahesh SIVARATRI, Bangalore (IN); Raghu SHAMASUNDAR, Bangalore (IN); Sushma BIDRUPANE, Bangalore (IN); Pradeep SEGU, Bangalore (IN); Srihari JAYATHIRTHA, Bangalore (IN)

(73) Assignee: Honeywell International Inc.

(21) Appl. No.: 16/432,630

(22) Filed: Jun. 5, 2019

(51) Int. Cl. G09B 19/16; G09B 9/08; B64D 45/00

(52) U.S. Cl. CPC G09B 19/165; B64D 2045/0085; B64D 45/00; G09B 9/08

(57) ABSTRACT

Systems and methods are disclosed for generating programs for aircraft training. For example, a method may include: determining a first type of aircraft for which a user is to be trained; determining, based on profile data of the user, one or more other types of aircraft on which the user has been trained; selecting, from a plurality of training modules, a training module including content providing training on a difference between the first type of aircraft and one of the one or more other types of aircraft or training on a topic on which a training module is unavailable for each one of the one or more other types of aircraft; generating a training program including the selected training module; and presenting the training program to the user.

### TECHNICAL FIELD

Various embodiments of the present disclosure relate generally to systems and methods for generating training programs and, more particularly, to systems and methods for generating aircraft training programs adapted to a user's existing training and other characteristics.

### BACKGROUND

Different types of aircraft have different features. Therefore, pilots who intend to fly multiple types of aircraft should be regularly trained on each type of aircraft they intend to fly. Such training may include training in cockpit environments, technologies used in avionics, operational features, and aircraft performance capabilities.

Full training for a certain type of aircraft may be costly. Therefore, there is a need for systems and methods that provide adaptive, efficient, effective, and expeditious cross-aircraft training to experienced pilots based on their existing training in other types of aircraft. There is also a need for systems and methods to generate training programs for pilots based on their actual flight performance.

The present disclosure is, in certain aspects, directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for generating training programs on operation of aircraft.

For instance, a method for providing data for simulating avionics systems may include: determining a first type of aircraft for which a user is to be trained; determining, based on profile data of the user, one or more other types of aircraft on which the user has been trained; selecting, from a plurality of training modules, a training module including content providing training on a difference between the first type of aircraft and one of the one or more other types of aircraft or training on a topic on which a training module is unavailable for each one of the one or more other types of aircraft; generating a training program including the selected training module; and presenting the training program to the user.

Furthermore, a computer system for providing data for simulating avionics systems may include a memory storing instructions; and one or more processors configured to execute the instructions to perform operations. The operations may include: determining a first type of aircraft for which a user is to be trained; determining, based on profile data of the user, one or more other types of aircraft on which the user has been trained; selecting, from a plurality of training modules, a training module including content providing training on a difference between the first type of aircraft and one of the one or more other types of aircraft or training on a topic on which a training module is unavailable for each one of the one or more other types of aircraft; generating a training program including the selected training module; and presenting the training program to the user.

Furthermore, a non-transitory computer-readable medium storing instructions that, when executed by one or more processors, cause the one or more processors to perform a method for requesting data for simulating avionics systems. The method may include: determining a first type of aircraft for which a user is to be trained; determining, based on profile data of the user, one or more other types of aircraft on which the user has been trained; selecting, from a plurality of training modules, a training module including content providing training on a difference between the first type of aircraft and one of the one or more other types of aircraft or training on a topic on which a training module is unavailable for each one of the one or more other types of aircraft; generating a training program including the selected training module; and presenting the training program to the user.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a network environment for training program generation, according to one or more embodiments.

FIG. 2 illustrates the use of a training program generation process, according to one or more embodiments.

FIG. 3 illustrates data describing a correspondence between aircraft classifications, training module topics, and training modules.

FIG. 4 illustrates a method for generating a training program, according to one or more embodiments.

FIG. 5 illustrates a method for generating a training program, according to one or more embodiments.

FIG. 6 illustrates a computing device according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus.

In the following description, embodiments will be described with reference to the accompanying drawings. Various embodiments pertain to the generation of a training program for a pilot or other user. In most embodiments, a training program may be any collection of electronic documents, multimedia files, user interfaces, or the like. For example, a server system may store profiles of pilots and a collection of training modules that provide training for particular types of aircraft. When a pilot wishes to become trained in a new type of aircraft, the profile data of that pilot may be used to select training modules to form a training program. The profile data may include type rating information indicating that that the pilot is rated for certain types of aircraft, in which the pilot is already trained. To select training modules for a training program built for the pilot, the server system may utilize the type rating information to select difference training modules for the training program. Difference training modules may be designed to explain differences between the new type of aircraft for which training is sought and a type of aircraft on which the pilot is already trained. Additionally, the server system may select training modules based on pilot performance. For example, data recorded by on-board recording systems may be analyzed to obtain an evaluation of pilot performance. Such evaluations may be used to select training modules for a personalized training program. Therefore, the server system may generate a training program adapted to a pilot's existing training and flight performance profile.

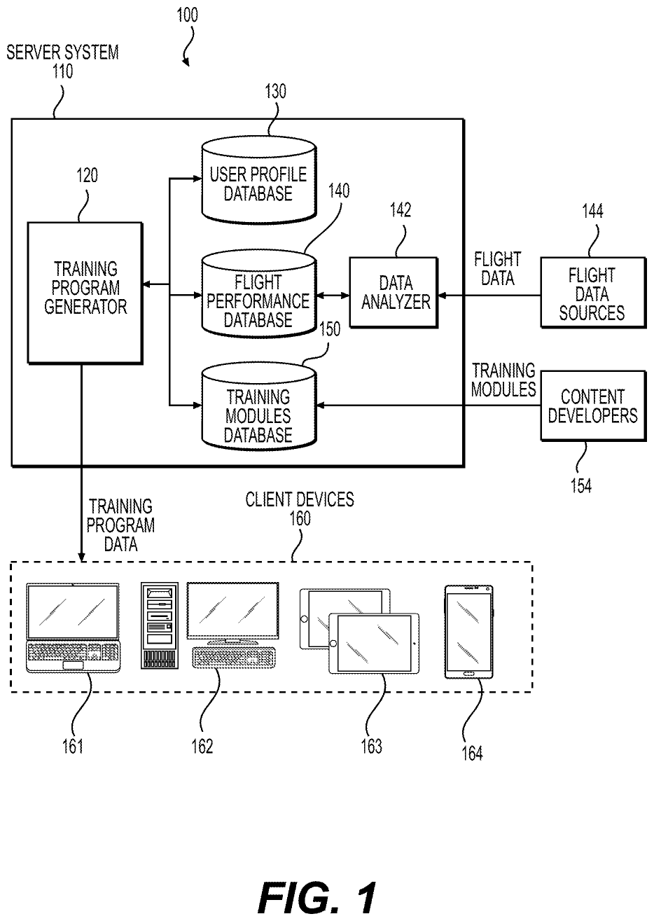

FIG. 1 illustrates a network environment 100 for training program generation, according to one or more embodiments of the present disclosure. The network environment 100 may include a server system 110 connected to various client devices 160. Server system 110 may include a training program generator 120, which may be a software application executed by one or more processors of the server system 110 to generate training programs for users of client devices 160.

Training programs generated by training program generator 120 may include content that provides training on topics relating to the operation of aircraft. Users of the client devices 160 may include pilots, aircraft crew members, flight instructors, and any other personnel who may utilize training programs generated by training program generator 120. In some implementations, server system 110 may be a cloud computing system, which may have scalable resources for computation and/or data storage.

As shown in FIG. 1, server system 110 may include various databases, such as user profile database 130, flight performance database 140, and training modules database 150. User profile database 130 and flight performance database 140 may store user-specific data, as described below.

User profile database 130 may store profile data of users. For each user, the corresponding profile data may include data describing characteristics of the user, such as any certificates (e.g., pilot certificates), licenses, ratings, and other information describing training or competencies of the user in operating aircraft. Ratings described by the profile data may include, for example, a rating for one or more categories of aircraft, one or more classes of aircraft, and/or one or more types of aircraft. In this disclosure, the term “type” may broadly refer to a type of aircraft as classified by any suitable methodology. In certain examples, a “type” of aircraft may refer to aircraft types designed by a regulatory body, such as the United States Federal Aviation Administration (FAA) or the European Aviation Safety Agency (EASA). In the context of ratings, a “type rating” may refer to a certification of a pilot by a regulatory body to fly aircraft of a certain type of aircraft, as designated by the regulatory body. Ratings stored in the user profile database 130 may also include instrument ratings in addition to aircraft category, class, or type ratings.

Flight performance database 140 may store flight performance data, which may include data describing the performance of a pilot or other crew member during actual flights. Flight performance data may also describe assessments of the performance of a pilot during such flights. In some embodiments, flight performance may be assessed by data analyzer 142 based on flight data receive from flight data sources 144.

Flight data sources 144 may include flight data recording systems that record actions of pilots and flight crew during a flight, such as quick access recorders (QAR), flight data recorders (FDR), cockpit voice recorders (CVR), Cockpit Voice and Data Recorder (CVDR), and any other types of flight recorders. Data gathered by a flight data recording system may be transmitted to the server system 110 through a communication network connecting between the aircraft and the server system 110. Such a communication network may include satellite communications and air-to-ground communications, for example. Flight data sources 144 may additionally or alternatively include other server systems that possess flight data, such as systems belonging to ground-based data centers and air traffic controllers.

Data analyzer 142 may be a software application executed by the one or more processors of the server system 110 to determine assessments of performance based on the flight data from flight data sources 144. An assessment of performance may include, for example, values of various parameters reflecting performance factors. The data analyzer 142 may include algorithms that analyze whether the recorded actions taken by a pilot or crew member adhered to standard operating procedures. Such algorithms may, for example, determine one or more actions expected to be taken in order to comply with a standard operating procedure under various certain operating conditions of the aircraft during a flight mission, and compare such actions with actions that were recorded to have been actually performed by the pilot or crew member. Such analysis may be performed in real time, using flight data received from aircraft in real time through the aforementioned communication network.

Training modules database 150 may store a plurality of training modules. A training module may serve as a component of a training program as described above. A training module may include any collection of content designed to provide training in a topic pertaining to operation of aircraft, such as the operation of a certain feature of an aircraft avionic system, or operation of an aircraft for a certain flight scenario.

Training modules may include presentations, lessons, instructions, and/or other content operating a feature of an aircraft, or operation an aircraft for a certain flight scenario. Such content may in include any form of media, such as text, images (e.g., flowcharts), videos, and other data. In some examples, training modules may include data used in flight simulations. For example, training modules may provide data for simulated free-play scenarios that are run on client devices 160. Training modules may be created by content developers 154, which may include one or more computer systems operated by personnel that develop training modules for storage in the server system 110.

The training modules database 150 may include training modules designed to train a user on a particular aircraft model or type of aircraft, such as an avionics feature (e.g., flight management system or flight management computer) of a particular aircraft model or type of aircraft, or the operation of that particular aircraft model or type of aircraft in a particular flight scenario. Such training modules may be referred to as model-specific or type-specific training modules. Model-specific and type-specific training modules may include difference training modules, designed to train a user for a particular aircraft model or type when the user is already trained in the same topic on a different aircraft model or type, as well as general training modules that do not rely on such pre-existing training. Difference training modules, which may also be referred to as differential training modules or cross-aircraft training modules, may explain detailed differences of a topic (e.g., feature or scenario) from one aircraft to another.

Model-specific or type-specific training modules in the training modules database 150 may be each be associated with an aircraft model or aircraft type. Additionally, the server system 110 may include a further database associating each aircraft model or type may be associated with tail numbers of aircraft belonging to that model or type.

A training program may include one or more training modules selected by the training program generator 120. A training program may be a training course or serve as a training course. Training programs generated by the training program generator 120 may be provided to the client devices 160 for display or usage on the client devices 160. Data that is transmitted to client devices 160 in order for client devices 160 to access or otherwise utilize the training programs may be referred to as training program data. Such data may include, for example, media content as described above, links to content stored on server system 110, data used to simulate avionics functionalities, and any other type of data that is used by the client devices 160 in order to view or utilize the training programs generated by server system 110. The server system 110, or any aspect thereof that implements the training program generator 120, may be referred to as a training platform.

Each of the client devices 160 may be a computer system, such as a laptop computer 161, a desktop computer 162, a tablet computer 163, or a smartphone 164. Each of the client devices 160 may include one or more processors configured to execute an application to view or otherwise utilize training program data. In some examples, training program data may include media content viewable by a web browser or other application executed by the client devices 160. Client devices 160 may be connected to the server system 110 through a communication network, such as the internet. This network may be the same as or different from the aforementioned communication network connecting between the server system 110 and the flight data sources 144.

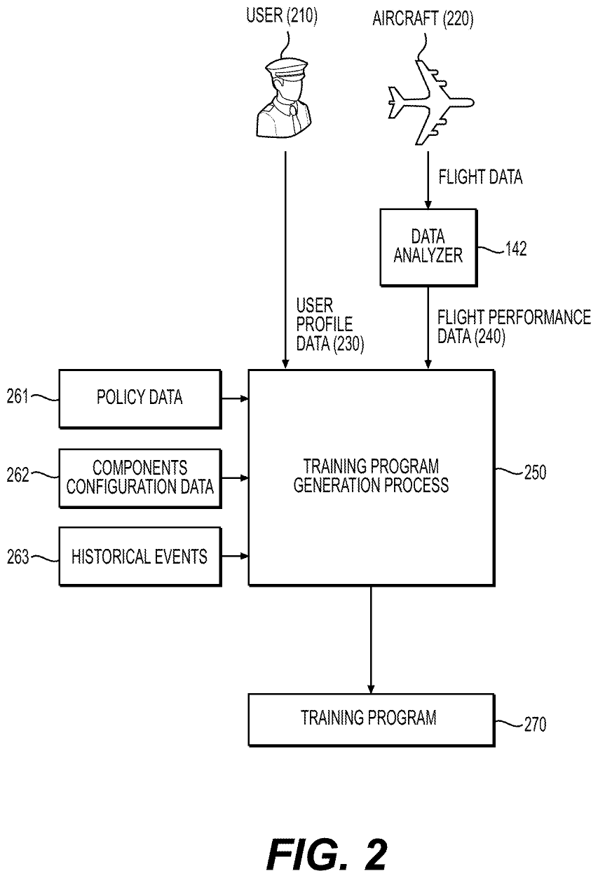

FIG. 2 is a diagram that illustrates various elements that may be used to generate a training program 270 using a training program generation process 250. Training program generation process 250 may be a process performed by the training program generator 120. The training program generation process 250 may utilize, for example, adaptive learning methods, adaptive moderator systems, and/or learning and filtering methods to process any input data used to generate training program 270. In implementations in which training program generation process 250 involves adaptive training methods, the server system 110 may also be referred to as an adaptive training platform.

Input data used to generate the training program 270 may include user profile data 230, which may be provided by a user 210 (e.g., pilot or crew), flight performance data 240, which may be generated by the data analyzer 142 based on flight data received from a flight data source 144 (e.g., aircraft 230 operated by the pilot or crew member 210) as described above, and additional data such as policy data 261, components configuration data 262, and historical events 263. Such additional data may be stored in one or more databases of the server system 110.

Policy data 261 may include data indicating training requirements for a user in order to comply with policies set by an airline, regulatory agencies, or other organizations. For example, if a pilot or crew member is to be trained for a certain type rating, the policy data 261 may indicate the topics on which the crew member is to be trained for purposes of obtaining the type rating. Such data may be used to select the training modules when generating the training program 270.

Components configuration data 262 may include line replaceable unit (LRU) data describing components of various aircraft. LRU data may include a table indicating the configuration of avionics data onboard different aircraft types and/or models.

Historical events 263 may include data indicating historical events that are relevant to training program selection, such as historical flight performance data.

Additionally, the training program generation process 250 may receive a training objective indicating, for example, a type rating desired by the user. This training objective may be specified by the user 210 and may be used by the training program generation process 250 as an additional input for purposes of generating the training program 270. For example, the user 210 may specify that he or she wishes to be trained for a certain type rating. In other situations, training program 270 may be generated without specific specification of a training objective. For example, the server system 110 may detect that a user is in need of performance enhancement training based on flight performance data 240 and policy data 261.

The training program 270 generated by the training program generation process 250 may be, for example, a difference training program (based on, for example, crew profile and/or aircraft tail numbers), a pilot performance enhancement program, an event based program, a training program based on priority and filtering, or a training program that includes a combination of the foregoing characteristics.

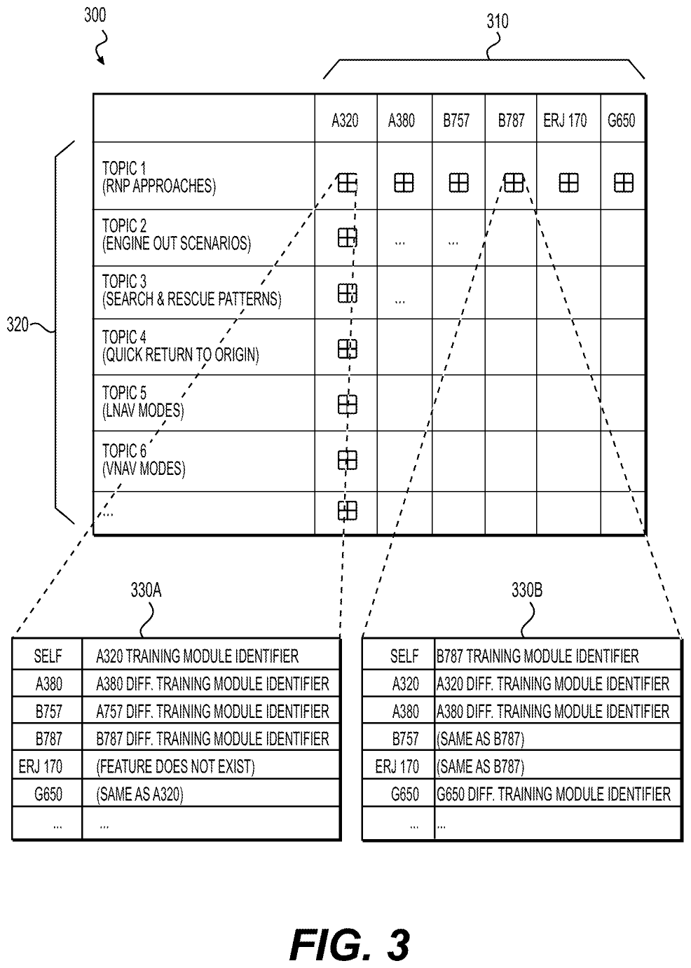

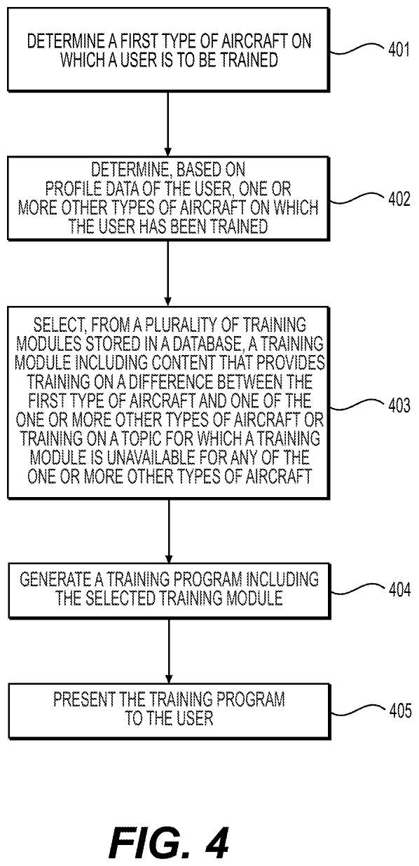

An example of a method for generating a training program 270 that provides difference training is described in below with reference to FIGS. 3-4. In general, based on user profile data pilot profile indicating the user's experience (e.g., existing type ratings), the training program generation process 250 may automatically build a difference training program that provides the user with type rating training for a new type of aircraft. With such a difference training program, there is no need for the user to take part in a complete program for the new type of aircraft. For example, if a pilot is already type-rated on A320 and B757 aircrafts and wishes to obtain type rating training for B787, the server system 110, as an adaptive training platform, may determine, using the training modules database 150 and any other data stored in the server system 110, the differences of B787 with the other two aircrafts, A320 and B757. Based on the differences identified, the server system 110 may build the difference training program with the following sets of training modules: difference training modules for topics (e.g., features or scenarios) that differ from topics (e.g., features or scenarios) of the other two types of aircraft (A320 and B757); and training modules for topics (e.g., features or scenarios) that are NOT available on the other two types of aircraft (A320 and B757).

FIG. 3 illustrates a table of correspondence data 300 describing a correspondence between aircraft classifications, training module topics, and training modules. FIG. 4 is a flowchart illustrating a method of using the correspondence data of FIG. 3.

In FIG. 3, the columns 310 may correspond to different aircraft classifications (e.g., aircraft model or aircraft types). In the instantly illustrated example, the columns 310 correspond to different aircraft types, referred to as A320, A380, B757, B787, E170, and G650. For example, “A320” may refer to a type of aircraft that includes the Airbus A-318, AA-319, A-320, and A-321 series, and “B757” may refer to a type of aircraft that includes Boeing 747, 747-100, 747-200, 747-300, and 747SP. It is noted that the correspondence data 300 is represented in FIG. 3 in a certain form for purposes of illustration. It is understood that the correspondence data 300 may be provided in any suitable manner (e.g., a plurality of tables having a relationship) that permits the uses described in this disclosure. The correspondence data may be stored in training modules database 150.

Rows 320 correspond to topics of training modules. For example, topics may include “RNP approaches,” “engine out scenarios,” “search and rescue patterns,” “quick return to origin,” “LNAV modes,” and “VNAV modes” as shown in FIG. 3. For each topic, the training modules database 150 may store one or more type-specific training module providing training on that topic for a particular type of aircraft. The correspondence data 300 may include training modules data indicating a list of training modules for each combination of aircraft classification and training feature. Training modules data 330A and 330B shown in FIG. 3 are examples of training modules data.

Training modules data 330A and 330B may identify the training module, if any, that the training program generation process 250 may select in order to train a user in a certain feature for a certain aircraft classification given a certain training state of the user (e.g., whether the user has been trained for the same feature but for another aircraft classification). Such identification may be in the form of an identifier. In some implementations, an identifier of a training module may be a resource location of the training module, such as a URL, or any identifier usable to retrieve the training module. Training module identifiers may be part of a key-value pair as shown in FIG. 3, wherein the key (as indicated by the left-most columns in training modules data 330A and 330B) may correspond to a type of aircraft for which the user has already been trained, in the case of difference training modules.

For example, the expression “A320 training module resource identifier” may represent a resource location, such as a URL or other address, for the A320 training module. This resource location for this training model is paired with a key of “self” to indicate that the training model is a training module that does not rely on existing training, as opposed to a difference training module designed based on preexisting training of the user. The expression “diff. training module identifier” may represent a resource location of a difference training module designed for users that have already been trained in a particular aircraft classification. For example “A380 diff. training module identifier” may represent a resource location of a difference training module designed for users that have already been trained in the A380 type of aircraft. A difference training module may explain the difference of a particular feature with the other aircraft. For example, a “A380 diff. training module” identified in the “A320” column for a specific topic may explain differences between A320 aircraft and A380 aircraft on that specific topic (e.g., differences between operating A320 aircraft and A380 aircraft in flying RNP approaches).

For a given feature, if the training module for the given aircraft classification is the same as the training module for a different aircraft classification, the identification may be an identifier for that same training module. For example, the expression “same as A320” in FIG. 3 may represent an annotation indicating that the training module for the topic in question is the same for both A320 and G650. If a training module does not exist for a certain other type of aircraft, an annotation may be made in the correspondence data, as represented by the expression “feature does not exist” in training modules data 330A, the expression “feature does not exist” may represent an annotation indicating that a training module for the topic “RNP approaches” does not exist for the aircraft type “ERJ 170.” Such annotation may be utilized by the sever system 110 to determine that a user who is type rated for ERJ 170 should receive some training module for “RNP approaches” for the A320 aircraft type.

As an example, if a user has already completed training for Airbus 380 for the feature of “RNP approaches” and wishes to receive training for A320 on the same topic, then the training program generation process 250 may select the A380 differential training module, rather than the basic A320 training module, as part of the training program for that user. A differential training module may be a reduced-content module that trains the user on differences between the training-target aircraft type, and the type of aircraft for which the user is already trained. If, instead, the user has already completed the training module for G650, then the training program generation process 250 may omit any training module for this feature, since the training module for the feature of “RNP approaches” for G650 aircraft is the same as the training module for the feature of “RNP approaches” for the A320 aircraft, as indicated by the notation “same as” in list 330A. The expression “feature does not exist” indicates that a training module ERJ 170 in the feature of “RNP approaches” does not exist. The value for “does not exist” may be implemented an empty or null value, for example.

As a further example, assume that the user is a pilot who already has a type rating on A320, ERJ 170 and G650 aircraft, as indicated by profile data of the user, and wishes to become type-rated on B787. Based on this pilot data, which may be stored in user profile database 130, the training program generation process 250 may build a difference training program for the B787 aircraft based on the information that the user already has a type rating on A320, ERJ 170 and G650 aircraft.

As a further example, if the training module database is configured such that the “RNP Approaches” and “Engine Out Scenario” training modules are the same between B757 and B787, a difference training program for B787 type rating for a user that already has a B757 type rating may omit training modules for these features, and instead only include other training modules that non-overlapping content. In this case, the training modules for the difference programs may include, for example, training modules for LNAV Modes and VNAV modes if they are not the same as the training modules for LNAV Modes and VNAV modes for another.

FIG. 4 illustrates a method for generating a training program that includes a difference training program. The method may be performed by server system 110.

Step 401 may include determining a first type of aircraft on which a user is to be trained. This determination may be, for example, based on a training objective specified by the user, and may be received by the server system 110 from the user or organization over a communications network connecting between the server system 110 and the user device 160 operated by the user.

Step 402 may include determining, based on profile data of the user, one or more other types of aircraft on which the user has been trained. This step may include retrieving profile data of the user from user profile database 130.

Step 403 may include selecting, from a plurality of training modules stored in a database (e.g., training modules database 150), a training module including content that provides training on a difference between the first type of aircraft and one of the one or more other types of aircraft or training on a topic for which a training module is unavailable for any of the one or more other types of aircraft. The one or more other types of aircraft may each be a type of aircraft that is different from the first type of aircraft. In general, this selection process may be based on any methodology discussed above in relation to FIG. 3.

Step 403 may include determining one or more topics on which the user is to be trained, in order to be trained for the aforementioned first type of aircraft. This one or more topics may be specified by the policy data described above, and may be based on the requirements for becoming type rated on a certain type of aircraft. Step 403 may further include, for each topic of the one or more topics, determining retrieving the training modules data for that topic and selecting a training module based on the training modules data. This process may include, for example, determining the entries in the training modules data corresponding to the one or more other types of aircraft.

Using training modules data 330A as an example, if the one or more other types of aircraft is B787, then the B787 difference training module may be selected. If the one or more other types of aircraft is B787 and G650 or G650 alone, then no training module for the topic of “RNP approaches” may be identified for this topic. Therefore, in general, the training module selected in step 403 may be selected from difference training modules that instruct users on differences between two aircrafts and general training modules for topics on which a training module is unavailable for aircraft types for which the user already has a type rating.

Step 404 may include generating a training program including the training module selected in step 403. The training program may include additional training modules selected in accordance with the methodologies described above.

Step 405 may include presenting the training program to the user. The presenting of the training program to the user may include, for example, transmission of content of any training module in the training program from the server 110 to the corresponding user device 160, the transmission of a user interface (e.g., an interface displayable in a web browser) enabling the user to obtain content of the training module, or any other manners of permitting the user to access or utilizes the training program.

According to the method illustrated in FIG. 4, a training program that is adapted to the user's existing training may be generated.

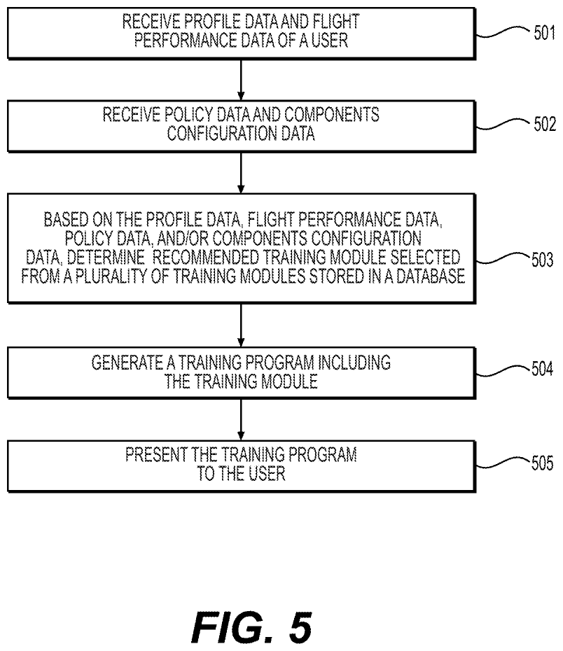

An example of a method for generating a training program for performance enhancement is described below with reference to FIG. 5. The method may be performed by server system 110. The method illustrated in FIG. 5 may be performed separately from, or in combination with, the method illustrated in FIG. 4. If performed in combination with the method of FIG. 4, the resulting training program may include training modules selected based on the method of FIG. 4 together with training modules selected based on the method of both FIG. 4.

Step 501 may include receiving profile data and flight performance data of a user. Such data may be retrieved from databases 130 and 140 described above. Step 502 may include receiving policy data and components configuration data, as described above in relation to FIG. 2.

Step 503 may include, based on the profile data, flight performance data, policy data, and/or components configuration data, determining a recommended training module selected from a plurality of training modules stored in a database (e.g., training modules database 150). This step may include determining a topic on which the user needs performance enhancement based on the flight performance data, and selecting the training module based on the determined topic. The selected training module may be a difference training module, or a general training module. By selecting the training module based on the flight performance data, the training module may be one that provides training on, for example, actions that should be taken under certain situations in order to conform to standard operations that the user failed to adhere to in a previous flight. In various embodiments, the training module may include advisory modules, real time situation modules, and/or any of the modules discussed above. The training program may also include various alerts, such as alerts on deficiencies in pilot performance determined by the server system 110.

Step 504 may include generating a training program including the identified training module. Such a training program may therefore be personalized to the user, based on the profile data and flight performance data specific to that user.

Step 505 may include presenting the training program to the user. This step may be performed in the manner described above in relation to step 405.

For example, data analyzer 142 may perform data analytics on the actual flight logs, flight reports, QAR data and/or other pilot performance data on each flight scenario or mission conducted by the user to determine actions performed by a pilot or other user under various circumstances. Such actions may be evaluated against the normal or standard operating procedures for that specific aircraft. These evaluation results, which may describe an assessment of how well a user performs, may be stored in flight performance database 140 in server system 110. Such assessment may include a rating such as “excellent,” “satisfactory,” or “needs improvement.” Improvements to actions performed during the flight may also be stored in the flight performance database 140.

Based on information stored in flight performance database, the training program generation process 250 may recommend certain pilot performance enhancement programs designed to enhance a user's abilities to conduct flight missions more accurately and safely. For example, training modules that cover pilot competencies for which the user is rated as “needs improvement” may be selected for the training program.

The methods illustrated in FIGS. 4 and 5 may additionally include the step of verifying that the user being serviced has logged in. For example, the server system 110 may determine the identity of a user that has logged in to a training program service provided by the server system 110, and retrieve data (e.g., the profile data and/or the flight performance data of the user) based on the determined identity of the user.

As described above, the server system 110 may provide a training platform for effective generation of training programs for pilots and other users. The training platform may have access to a continuously-expandable training modules database 150, as well as a user profile database 130. Such databases may permit the automatic generation of a difference training program for a new type rating, based on profile data stored in the user profile database 130. As described above, the training platform may be also equipped with data analytics to produce live flight performance data recorded by flight data recording systems. Based on such flight performance data, the training platform may automatically build a performance enhancement program personalized to a particular user.

Accordingly, systems and methods of the present disclosure improve technology used to provide training programs to pilots and other users, by providing a training platform configured to automatically build difference training program based on existing pilot training, as well as personalized performance enhancement programs on user-specific performance during actual flights.

In general, any process discussed in this disclosure that is understood to be computer-implementable, such as the processes illustrated in FIGS. 4-5, may be performed by one or more processors of a computer system, such as server system 110, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as server system 110 and client device 160, may include one or more computing devices. If the one or more processors of the computer system are implemented as a plurality of processors, the plurality of processors may be included in a single computing device or distributed among a plurality of computing devices. If a computer system comprises a plurality of computing devices, the memory of the computer system may include the respective memory of each computing device of the plurality of computing devices.

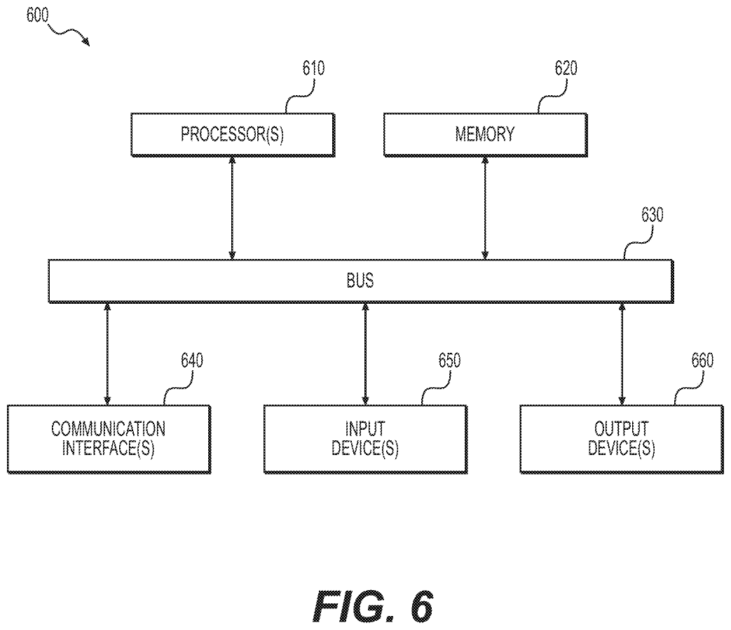

FIG. 6 illustrates an example of a computing device 600 of a computer system that may execute techniques presented herein. The computing device 600 may include processor(s) 610 (e.g., CPU, GPU, or other such processing unit(s)), a memory 620, and communication interface(s) 640 (e.g., a network interface) to communicate with other devices. Memory 620 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 620. The computing device 600 may, in some embodiments, further include input device(s) 650 (e.g., a keyboard, mouse, or touchscreen) and output device(s) 660 (e.g., a display, printer). The aforementioned elements of the computing device 600 may be connected to one another through a bus 630, which represents one or more busses. In some embodiments, the processor(s) 610 of the computing device 600 include both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the

[symbol]

What is claimed is:

1. A computer-implemented method for generating programs for aircraft training, the method comprising:
determining a first type of aircraft for which a user is to be trained;
determining, based on profile data of the user, one or more other types of aircraft on which the user has been trained;
selecting, from a plurality of training modules, a training module including content providing training on a difference between the first type of aircraft and one of the one or more other types of aircraft or training on a topic on which a training module is unavailable for each one of the one or more other types of aircraft;
generating a training program including the selected training module; and
presenting the training program to the user.

2. The method of claim 1, wherein the determining the one or more other types of aircraft on which the user has been trained includes:
receiving the profile data of the user, the profile data indicating that the user has a type rating for each of the one or more other types of aircraft; and
determining, based on the profile data, that the user has been trained on each of the one or more other types of aircraft based on the type rating for each of the one or more other types of aircraft.

3. The method of claim 1, wherein:
the content of the training module provides training on the difference between the first type of aircraft and the one of the one or more other types of aircraft, and
the plurality of training modules is stored in a database, in which the selected training module is associated with the first type of aircraft and the one of the one or more other types of aircraft.

4. The method of claim 1, wherein the selecting the training module includes:
determining a topic for the user to receive type rating training for the first type of aircraft; and
selecting the training module from a plurality of training modules associated with the determined topic.

5. The method of claim 1, further comprising:
receiving flight performance data of the user and policy data; and
based on the profile data, the flight performance data, and the policy data, determine a second training module, selected from the plurality of training modules, to enhance a flight performance of the user.

6. The method of claim 5, further comprising:
generating the flight performance data by analyzing flight data recorded by a flight data recording system of an aircraft operated by the user.

7. The method of claim 5, wherein the determining the second training module includes:
determining a topic on which the user needs performance enhancement based on the flight performance data; and
selecting the second training module based on the determined topic.

8. A computer system for generating programs for aircraft training, the computer system comprising
a memory storing instructions; and
one or more processors configured to execute the instructions to perform operations including:
determining a first type of aircraft for which a user is to be trained;
determining, based on profile data of the user, one or more other types of aircraft on which the user has been trained;
selecting, from a plurality of training modules, a training module including content providing training on a difference between the first type of aircraft and one of the one or more other types of aircraft or training on a topic on which a training module is unavailable for each one of the one or more other types of aircraft;
generating a training program including the selected training module; and
presenting the training program to the user.

9. The computer system of claim 8, wherein the determining the one or more other types of aircraft on which the user has been trained includes:
receiving the profile data of the user, the profile data indicating that the user has a type rating for each of the one or more other types of aircraft; and
determining, based on the profile data, that the user has been trained on each of the one or more other types of aircraft based on the type rating for each of the one or more other types of aircraft.

10. The computer system of claim 8, wherein
the content of the training module provides training on the difference between the first type of aircraft and the one of the one or more other types of aircraft, and
the plurality of training modules is stored in a database, in which the selected training module is associated with the first type of aircraft and the one of the one or more other types of aircraft.

11. The computer system of claim 8, wherein the selecting the training module includes:
determining a topic for the user to receive type rating training for the first type of aircraft; and
selecting the training module from a plurality of training modules associated with the determined topic.

12. The computer system of claim 8, wherein the operations further include:
receiving flight performance data of the user and policy data; and
based on the profile data, the flight performance data, and the policy data, determine a second training module, selected from the plurality of training modules, to enhance a flight performance of the user.

13. The computer system of claim 12, wherein the operations further include:
generating the flight performance data by analyzing flight data recorded by a flight data recording system of an aircraft operated by the user.

14. The computer system of claim 12, wherein the determining the second training module includes:
determining a topic on which the user needs performance enhancement based on the flight performance data; and
selecting the second training module based on the determined topic.

15. A non-transitory computer-readable medium storing instructions that, when executed by one or more processors of a computer system, cause the one or more processors to perform a method for generating programs for aircraft training, the method comprising:
determining a first type of aircraft for which a user is to be trained;
determining, based on profile data of the user, one or more other types of aircraft on which the user has been trained;
selecting, from a plurality of training modules, a training module including content providing training on a difference between the first type of aircraft and one of the one or more other types of aircraft or training on a topic on which a training module is unavailable for each one of the one or more other types of aircraft;
generating a training program including the selected training module; and
presenting the training program to the user.

16. The non-transitory computer-readable medium of claim 15, wherein the determining the one or more other types of aircraft on which the user has been trained includes:
receiving the profile data of the user, the profile data indicating that the user has a type rating for each of the one or more other types of aircraft; and
determining, based on the profile data, that the user has been trained on each of the one or more other types of aircraft based on the type rating for each of the one or more other types of aircraft.

17. The non-transitory computer-readable medium of claim 15, wherein
the content of the training module provides training on the difference between the first type of aircraft and the one of the one or more other types of aircraft, and
the plurality of training modules is stored in a database, in which the selected training module is associated with the first type of aircraft and the one of the one or more other types of aircraft.

18. The non-transitory computer-readable medium of claim 15, wherein the selecting the training module includes:
determining a topic for the user to receive type rating training for the first type of aircraft; and
selecting the training module from a plurality of training modules associated with the determined topic.

19. The non-transitory computer-readable medium of claim 15, wherein the method further includes:
receiving flight performance data of the user and policy data; and
based on the profile data, the flight performance data, and the policy data, determine a second training module, selected from the plurality of training modules, to enhance a flight performance of the user.

20. The non-transitory computer-readable medium of claim 19, wherein the method further includes:
generating the flight performance data by analyzing flight data recorded by a flight data recording system of an aircraft operated by the user.
